(19) United States
(12) Patent Application Publication
(10) Pub. No.: US 2010/0057656 A1
(43) Pub. Date: Mar. 4, 2010

(54) DEVICE, SYSTEM, AND METHOD OF DETERMINING A SOLUTION SCHEME OF A POLY-ALGORITHM SOLVER

(76) Inventors: David Kuck, Champaign, IL (US); Henry Gabb, Champaign, IL (US); Chi Leung David Wong, Champaign, IL (US)

Correspondence Address: Shiloh et al., C/O INTELLEVATE , LLC, P.O BOX 52050, MINNEAPOLIS, MN, 55402, US

(21) Appl. No.: 12/198,178

(22) Filed: Aug. 26, 2008

(51) Int. Cl. G06N 5/02

(52) U.S. Cl. 706/46

(57) ABSTRACT

Device, system, and method of determining a solution scheme of a poly-algorithm solver. Some embodiments include a method of determining a solution scheme to be applied to input data by a poly-algorithm solver including a plurality of algorithms, the method including receiving a calling sequence including input values of a predefined set of parameters corresponding to the input data; based on the input values, choosing one of first and second algorithm selection models for selecting one or more of the algorithms to be applied to the input data by the solver. Other embodiments are described and claimed.

### BACKGROUND

A poly-algorithm solver, e.g., the SPIKE solver, may include a plurality of different solution schemes constructed from a plurality of predefined algorithms.

A solution scheme may have advantages and/or disadvantages compared to other solution schemes depending, for example, on one or more characteristics of input data to be handled by the solver, and/or the architecture of processor executing the solver.

Specialized knowledge may be required in order to determine an optimal solution scheme to be used. Using a sub-optimal solution scheme may result in poor performance or failure to find a solution.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic illustration of a method of determining a solution scheme of a poly-algorithm solver, in accordance with some demonstrative embodiments.

FIG. 3 is a schematic illustration of a method of constructing first and second algorithm selection models, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Although portions of the discussion herein relate, for demonstrative purposes, to wired links and/or wired communications, some embodiments may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

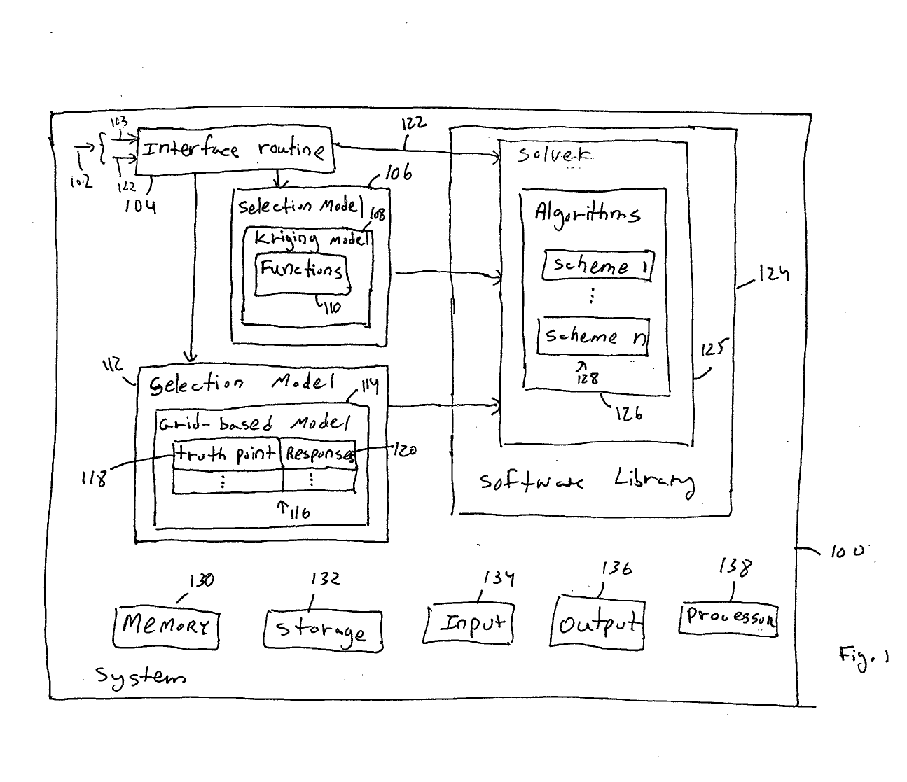

FIG. 1 schematically illustrates a block diagram of a system 100 including a software library 124, which includes a plurality of algorithms 126 of a poly-algorithm solver 125, in accordance with some demonstrative embodiments. In one embodiment, solver 125 may include the SPIKE solver. In other embodiments, solver 125 may include any other suitable solver to solve any suitable computational problem.

Solver 125 may be executed, for example, by a processor 138 executing instructions stored in a memory 130 and/or storage 132. Processor 138 includes, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller. Memory 130 includes, for example, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. Storage 132 includes, for example, a hard disk drive, a floppy disk drive, a compact disk (CD) drive, a CD-ROM drive, a digital versatile disk (DVD) drive, or other suitable removable or non-removable storage units.

In some embodiments, a plurality of solution schemes, e.g., n solution schemes 128, may use algorithms 126. In one embodiment, a first solution scheme of schemes 128 may use one or more of algorithms 126; a second solution scheme of schemes 128 may use one or more of algorithms 126, different from the algorithms of the first solution scheme, and so on. Solution schemes 128 may have optimal performance, for example, for different settings of one or more parameters related to input data 122 and/or architecture-related parameters corresponding to different possible architectures of processor 138, e.g., a number and/or type of cores included in processor 138, an arrangement of one or more of cores of processor 138 in one or more core clusters, and the like.

In some embodiments, system 100 may also include an interface routine 104 to receive a calling sequence 102 including input values 103 of a predefined set of parameters corresponding to input data 122, which is to be provided to solver 125. Input values may 103 also include values of one or more architecture-related parameters corresponding to processor 138. Based on input values 103, interface routine 104 may choose one of at least a first algorithm-selection model 106 and a second algorithm-selection model 112 for selecting one or more of algorithms 126 to be applied as a solution scheme to input data 122 by solver 125, e.g., as described in detail below.

In some embodiments, model 106 may include an interpolation-based model, for example, a kriging model 108; and model 112 may include a grid-based model 114, e.g., as described in detail below. Although some embodiments are described herein with reference to the kriging model, other embodiments may include any other suitable interpolation-based model.

In some embodiments, kriging model 108 may include a plurality of interpolation functions 110 to determine expected response values of algorithms 126, respectively, within a domain covering predefined ranges of values of the parameters corresponding to input data 122. The domain may include, for example, a training domain in which kriging model 108 has been constructed, e.g., as described below; and/or any other suitable domain, e.g., larger than the training domain. The response values may represent a performance metric of solver 125.

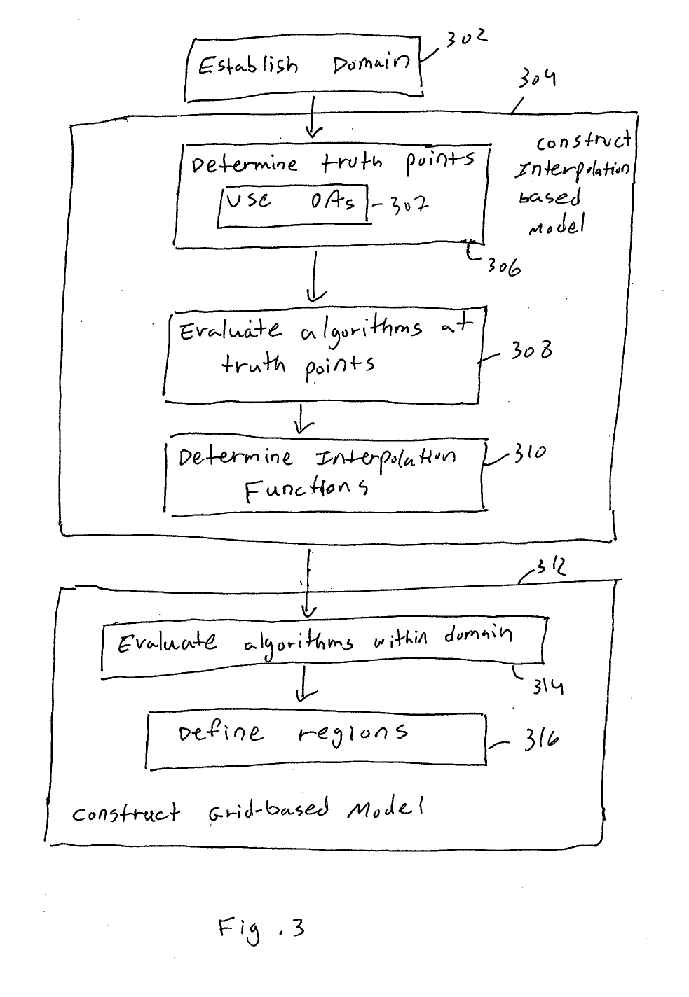

In some embodiments, grid-based model 114 includes a plurality of predetermined response values 120 of the plurality of algorithms 126, respectively, corresponding to a plurality of truth points 118 within at least one region of the domain. The term “truth point” as used herein may include a point in the domain having a predetermined response value, e.g., known from direct experiment rather than being predicted. Grid-based model 114 may be constructed, for example, by imposing a fixed grid of truth points over the region, e.g., as described below with reference to FIG. 3. In one embodiment, grid-based model 114 may include a table 116 including a plurality of entries, which include the plurality of truth points 118 and the corresponding plurality of response values 120, respectively.

In some embodiments, kriging model 108 may determine a point of the domain represented by input values 103 (“the evaluated domain point”), and use the plurality of algorithms 110 to determine a respective plurality of response values (“the kriging response values”) corresponding to the plurality of algorithms 126, respectively, at the evaluated domain point. According to the kriging response values, kriging model 108 may select one or more of algorithms 126 to be applied as a solution scheme to input data 122 by solver 125.

Grid-based model 114 may determine the evaluated domain point represented by input values 103, and determine a plurality of response values (“the grid-based response values”) corresponding to the plurality of algorithms 126, respectively, at the evaluated domain point. Grid-based model 114 may determine the grid-based response values, for example, by a combination, e.g., a weighted average or any other suitable interpolation, of two or more response values 120 corresponding to truth points 118, which are located in proximity to the domain point. According to the grid-based response values, grid-based model 114 may select one or more of algorithms 126 to be applied as a solution scheme to input data 122 by solver 125.

In some embodiments, a kriging model, e.g., model 106, may be constructed to accurately predict response values over relatively large portions of the domain, while using predetermined response values corresponding to a lesser number truth points, e.g., compared to the number truth points required for construction of a grid-based model, e.g. model 114. The kriging model may be constructed relatively quickly and/or efficiently compared to constructing a grid-based model covering the same domain, e.g., since evaluating truth points may be computationally expensive. However, the kriging model may have a reduced accuracy within one or more regions of the domain, e.g., in regions wherein the values of the parameters corresponding to input data 122 are noisy and/or discontinuous.

In some embodiments, interface routine 104 may choose grid-based model 114 if input values 103 are included within at least one region of grid-based model 114, e.g., as described below.

In some embodiments, system 100 may include or may be part of a computing system including an input unit 134, an output unit 136, and/or any other suitable component. Input unit 134 includes, for example, a keyboard, a keypad, a mouse, a touch-pad, a stylus, a microphone, or other suitable pointing device or input device. Output unit 136 include, for example, a cathode ray tube (CRT) monitor or display unit, a liquid crystal display (LCD) monitor or display unit, a screen, a monitor, a speaker, or other suitable display unit or output device. Memory 130 and/or storage 132 may, for example, store data processed by system 100. In some embodiments, interface routine 104, selection model 106, selection model 112, and/or software library may result from processor 138 executing instructions stored by memory 126 and/or storage 128.

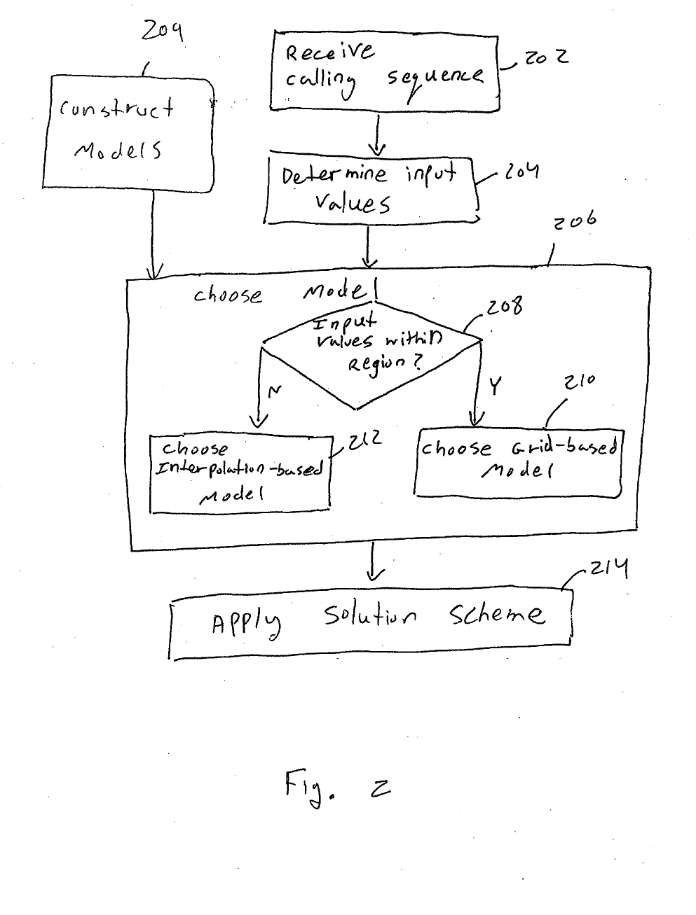

Reference is now made to FIG. 2, which schematically illustrates a method of determining a solution scheme of a poly-algorithm solver, in accordance with some demonstrative embodiments. In some non-limiting embodiments, one or more operations of the method of FIG. 2 may be performed by one or more elements of system 100 (FIG. 1), for example, interface routine 104 (FIG. 1), to determine a solution scheme to be applied to input data by a poly-algorithm solver including a plurality of algorithms.

As indicated at block 202, the method may include receiving a calling sequence including the input data. For example, the input data may include an input matrix to be provided to the solver.

As indicated at block 204, the method may include determining input values of a predefined set of one or more parameters corresponding to the input data; and/or one or more architecture-related parameters corresponding to the architectures of processor 138. For example, the input values may include, a size of the matrix, a bandwidth of the matrix, a diagonal dominance of the matrix, a sparsity of the matrix, a number and/or arrangement of one or more processors executing the solver, and the like.

As indicated at block 206, the method may include choosing one of first and second algorithm-selection models for selecting one or more of the algorithms as a solution scheme, based on the input values. The first algorithm-selection model includes, for example, an interpolation-based model, and the second algorithm selection model includes a grid-based model.

In one embodiment, the interpolation-based model includes a plurality of interpolation functions to determine expected response values of the plurality of algorithms, respectively, within a domain covering defined ranges of values of the parameters. For example, the interpolation-based model may include a kriging model. The grid-based model includes a plurality of predetermined response values of the algorithms within at least one region of the domain.

As indicated at block 208, choosing one of the first and second algorithm-selection models may include determining whether or not the input values are within a region of the grid-based model.

As indicated at block 210, the method may include choosing the grid-based model, e.g., if the input values are included within a region of the grid-based model.

As indicated at block 212, the method may include choosing the interpolation-based model, e.g., if the input values are not included within a region of the grid-based model.

As indicated at block 214, the method may include applying to the input data the selected solution scheme.

As indicated at block 209, in some embodiments, the method may include constructing the first and/or second algorithm-selection models, e.g., offline, for example, prior to receiving the calling sequence. Constructing the first and/or second models may include performing, for example, one or more of the operations discussed below with reference to FIG. 3.

Reference is made to FIG. 3, which schematically illustrates a method of constructing first and second algorithm-selection models, in accordance with some demonstrative embodiments.

In some embodiments, one or more operations of the method of FIG. 3 may be implemented for constructing an interpolation-based algorithm-selection model and a grid-based algorithm-selection model corresponding to select one or more of a plurality of algorithms based on a predefined set of parameters (“variables”). The set of parameters may include one or more parameters corresponding to input data to be handled by a poly-algorithm solver implementing the plurality of algorithms, and/or one or more architecture-related parameters corresponding to a processor executing the solver, e.g., as described herein. For example, the input data may include a matrix, e.g., if the plurality of algorithms includes algorithms of the SPIKE solver. The parameters may include, for example, the matrix characteristics, e.g., size, bandwidth, diagonal dominance, sparsity, and the like; and/or architecture-related parameters, e.g., number of processors, cluster arrangement, and the like.

As indicated at block 302, the method may include establishing a training domain based on predefined ranges corresponding to the set of parameters. For example, if the set of parameters includes first and second parameters, denoted iv1 and iv2, respectively; then the training domain may include a two-dimensional domain, e.g., a matrix, corresponding to the ranges of the first and second parameters. For example, the range of the first parameter may include the integers between 0 and 6, inclusive; and the range of the second parameter may include the integers between 2 and 5, inclusive. Accordingly, the training domain may include twenty-eight truth points corresponding to twenty eight different possible combinations between the seven possible values of the first parameter, and the four different possible values of the second parameter.

As indicated at block 304, the method may include constructing the interpolation-based model over the training domain, e.g., over the entire training domain.

As indicated at block 306, constructing the interpolation-based model may include determining a plurality of truth points within the training domain to be used by the interpolation-based model (“the interpolation-based truth points”).

As indicated at block 307, in some embodiments determining the plurality of interpolation-based truth points may include applying Orthogonal Arrays (OA) to select, e.g., intelligently, the interpolation-based truth points. For example, eight interpolation-based truth points may be selected from the twenty-eight truth points. In other embodiments, any other space-filling method may be used to determine and/or select the plurality of interpolation-based truth points.

As indicated at block 308, constructing the interpolation-based model may include evaluating the plurality of algorithms at the plurality of constructing the interpolation-based truth points, e.g., to determine a plurality of evaluated responses corresponding to the plurality of interpolation-based truth points.

As indicated at block 310, constructing the interpolation-based model may include determining a plurality of interpolation functions corresponding to the plurality of algorithms, respectively, based on the evaluated response values of the algorithms at the interpolation-based truth points. The plurality of interpolation functions may be used to determine expected response values of the plurality of algorithms, respectively, within any suitable domain, e.g., including at least the training domain.

As indicated at block 312, the method may include constructing the grid-based model within at least one region of the domain, e.g., as described in detail below.

As indicated at block 314, the method may include evaluating the plurality of algorithms at a set of points within the training domain (“the evaluated truth points”). For example, the set of points may include one or more of the truth points other than the interpolation-based truth points, e.g., all other truth points of the training domain. For example, the set of points may include one or more, e.g., all, of the twenty truth points other than the eight interpolation-based truth points.

As indicated at block 316, the method may include defining at least one region to include one or more points of the set of points, at which an inaccuracy of the interpolation functions, e.g., a difference between an expected response value and an actual response value, is equal to or greater than a predefined threshold, e.g., 20%. Accordingly, the grid-based model may include a plurality of evaluated response values of the plurality of algorithms, respectively, corresponding to the one or more points.

In some embodiments, the construction of the interpolation-based and grid-based algorithm-selection models, e.g., as described above, may be implemented in a relatively quick, simple, and/or efficient manner to allow selecting a solution-scheme with a relatively high level of accuracy, e.g., even within regions where the input data are noisy and/or discontinuous.

In some embodiments, the interpolation-based and grid-based algorithm selection models may be updated, e.g., relatively easily and/or efficiently, to reflect modifications in the plurality of algorithms. For example, upon adding a new algorithm, the interpolation-based selection model may be updated by determining an additional interpolation function corresponding to the new algorithm, e.g., while maintaining the other interpolation functions unchanged. Similarly, one or more of the interpolation functions, e.g., all of the interpolation functions, of the interpolation-based selection model may be recalibrated with additional truth points. The grid-based may be updated relatively easily, e.g., using the previously evaluated responses.

Some embodiments may be implemented to automatically and/or dynamically determine a solution scheme to be applied by a solver, e.g., without and/or independently of a user of the solver.

Although some embodiments are described herein with reference to the SPIKE solver, other embodiments may include any other suitable type of poly-algorithm problem and/or solver, e.g., which may be expressed in terms of independent variables (parameters) and response variables.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and/or an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of determining a solution scheme to be applied to input data by a poly-algorithm solver including a plurality of algorithms, the method comprising:
receiving a calling sequence including input values of a predefined set of parameters corresponding to said input data; and
based on said input values, choosing one of first and second algorithm-selection models for selecting one or more of said algorithms to be applied to said input data by said solver.

2. The method of claim 1, wherein said first algorithm-selection model includes an interpolation-based model, and wherein said second algorithm selection model includes a grid-based model.

3. The method of claim 2, wherein said interpolation-based model includes a plurality of interpolation functions to determine expected response values of said plurality of algorithms, respectively, within a domain covering defined ranges of values of said parameters,
and wherein said grid-based model includes a plurality of predetermined response values of said algorithms within at least one region of said domain.

4. The method of claim 3, wherein said choosing comprises choosing said grid-based model if said input values are included within said at least one region.

5. The method of claim 3 comprising:
determining a plurality of truth points within said domain;
evaluating said plurality of algorithms at said plurality of truth points; and
determining said interpolation functions based on the values of said algorithms at said truth points.

6. The method of claim 5 comprising:
evaluating said plurality of algorithms at a set of points within said domain; and
defining said region to include one or more of points of said set of points, at which an inaccuracy of said interpolation functions is greater than a predefined threshold.

7. The method of claim 3 comprising updating one or more of said plurality of functions based on a modification to one or more of said plurality of algorithms.

8. The method of claim 2, wherein said interpolation-based model comprises a kriging model.

9. A computer program product comprising a computer-useable medium including a computer-readable program, wherein the computer-readable program when executed on a computer causes the computer to:
receive a calling sequence including input values of a predefined set of parameters corresponding to input data for a poly-algorithm solver including a plurality of algorithms; and
based on said input values, choose one of first and second algorithm-selection models for selecting one or more of said algorithms to be applied by said solver to said input data.

10. The computer program product of claim 9, wherein said first algorithm-selection model includes an interpolation-based model, and wherein said second algorithm selection model includes a grid-based model.

11. The computer program product of claim 10, wherein said interpolation-based model includes a plurality of interpolation functions to determine expected response values of said plurality of algorithms, respectively, within a domain covering defined ranges of values of said parameters,
and wherein said grid-based model includes a plurality of predetermined response values of said algorithms within at least one region of said domain.

12. The computer program product of claim 11, wherein said computer-readable program causes the computer to choose said grid-based model if said input values are included within said at least one region.

13. The computer program product of claim 10, wherein said interpolation-based model comprises a kriging model.

14. The computer program product of claim 9, wherein said computer-readable program, when executed by the computer, results in a user callable interface routine to receive said calling sequence, and to choose one of said first and second algorithm-selection models for selecting one or more of said algorithms from a software library.
